(19) United States
(12) Patent Application Publication
(10) Pub. No.: US 2021/0383108 A1
(43) Pub. Date: Dec. 9, 2021

(54) IMAGE PROCESSING APPARATUS, SYSTEM, CONVERSION METHOD, AND RECORDING MEDIUM

(71) Applicant: Shinya ITOH, Tokyo (JP)

(72) Inventor: Shinya ITOH, Tokyo (JP)

(73) Assignee: Ricoh Company, Ltd., Tokyo (JP)

(21) Appl. No.: 17/324,516

(22) Filed: May 19, 2021

(30) Foreign Application Priority Data
Jun. 3, 2020 (JP) 2020-096954

(51) Int. Cl. G06K 9/00; G06K 9/18; G06K 9/34; H04N 1/00

(52) U.S. Cl. CPC G06K 9/00463; G06K 9/18; G06K 2209/01; G06K 9/00449; H04N 1/00331; G06K 9/348

(57) ABSTRACT

An image processing apparatus, system, method, and control program stored in a non-transitory recording medium are provided each of which obtains image data of a document; determines an arrangement pattern of each of a plurality of character strings in the image data, based on positional relationship of the plurality of character strings; and generates a text data file including the plurality of character strings each being arranged according to the arrangement pattern that is determined.

### CROSS-REFERENCE TO RELATED APPLICATIONS

This patent application is based on and claims priority pursuant to 35 U.S.C. § 119(a) to Japanese Patent Application No. 2020-096954, filed on Jun. 3, 2020, in the Japan Patent Office, the entire disclosure of which is hereby incorporated by reference herein.

### BACKGROUND

### Technical Field

The present disclosure relates to an image processing apparatus, a system, a conversion method, and a recording medium.

### Related Art

According to the related art, a paper document may be scanned into image data, and character recognition processing such as OCR processing may be applied to such image data to convert the image data into a tile such as in Office Open XML Document format. In this way, a paper document can he converted into a text data file, which may be edited by a word processor installed on a personal computer.

### SUMMARY

Example embodiments include an image processing apparatus, system, method, and control program stored in a non-transitory recording medium, each of which obtains image data of a document; determines an arrangement pattern of each of a plurality of character strings in the image data, based on positional relationship of the plurality of character strings; and generates a text data file including the plurality of character strings each being arranged according to the arrangement pattern that is determined.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a hardware configuration of a system according to an embodiment;

FIG. 2 is a diagram illustrating a hardware configuration of a multi-functional peripheral (MFP), as an example of image processing apparatus, according to the embodiment;

FIG. 3 is a functional block diagram provided by software installed at the image processing apparatus according to the embodiment;

FIG. 4 is a diagram illustrating functions performed by a file converter of the image processing apparatus according to the embodiment;

FIG. 5 is a flowchart illustrating processing of converting a text file, performed by the image processing apparatus, according to the embodiment;

FIGS. 6A to 6D are an illustration for explaining an example of generating a text file including character strings having a column relationship in the text file conversion process according to the embodiment;

FIGS. 7A to 7D are an illustration for explaining an example of generating a text file including character strings having a multi-layer relationship in the text file conversion process according to the embodiment;

FIGS. 8A to 8D are an illustration for explaining an example of generating a text file including character strings having neither column relationship nor multi-layer relationship in the text file conversion process according to the embodiment; and

FIGS. 9A and 9B are an illustration of an example of generating a text data file of character strings in an image, according to the related art.

The accompanying drawings are intended to depict embodiments of the present invention and should not be interpreted to limit the scope thereof. The accompanying drawings are not to he considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure is described with reference to the following embodiments, but the present disclosure is not limited to the embodiments described herein. In each of figures described below, the same reference numerals are used to refer to common elements, and the description thereof will be omitted as appropriate.

In converting a paper document into a text data file, there are some techniques for improving accuracy in recognizing characters (referred to character strings) in a document image.

For example. Japanese Patent Registration No. 5538812 discloses a technique for correcting a result of character recognition based on a font and size of a character in a scanned document.

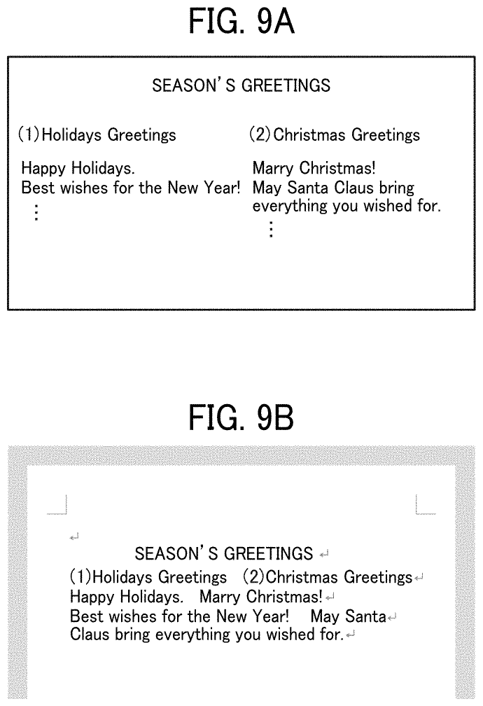

As illustrated in FIGS. 9A and 9B, according to a technique disclosed in, for example, Japanese Patent Registration No. 5538812, a text data file may not contain accurate information depending on a structure of character string in the document. FIGS. 9A and 9B illustrate example operation of generating a text data file containing character strings extracted from a document image, using this technique. FIG. 9A illustrates an example paper document to be converted into a text data file. FIG. 9A illustrates, as an example, a paper document having two columns printed thereon.

Assuming that the paper document illustrated in FIG. 9A is scanned into text data, the text data file illustrated in FIG. 9B may be generated. FIG. 9B illustrates an example screen of text data, displayed by a word processor based on the text data file that cannot be properly converted from the paper document of FIG. 9A. Specifically, if a document having a two-column structure is not properly converted, a document in which the respective columns are mixed into one column may be output as illustrated in FIG. 9B. For example, as illustrated in FIG. 9A, “Happy Holidays” should be followed by “Best wishes”. However, as illustrated in FIG. 9B, the character string “Marry Christmas!” in the adjacent column is recognized as a character string on the same line as the character string “Happy Holidays”, and a document having inappropriate contents may be Output. If such a text data file with low reproducibility is output, it takes time and effort to re-edit, thus lowering operability for the user.

In view of the above, a technique for generating a text data file from a scanned document, while considering a structure of character strings in the document, is desired.

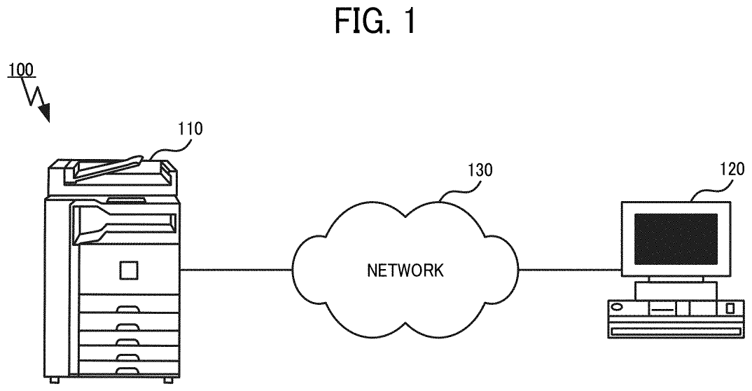

FIG. 1 is a schematic diagram illustrating a hardware configuration of a system 100 according to this embodiment. FIG. 1 illustrates, as an example, an environment in which a multi-function peripheral (MFP) 110 and a personal computer 120 are connected via a network 130 such as the Internet or a local area network (LAN). The MFP 110 or the personal computer 120 may be connected to the network 130 by any means, such as wired or wireless network.

The MFP 110 is an example of an image processing apparatus, which prints an image based on a print job or scans paper document into electronic file, for example. In the following examples, the MFP 110 is assumed to at least have a scanning function and an image processing function. Specifically, the MFP 110 scans a paper document into a document image (may be referred to as a scanned image), and processes the document image to generate a text file including character strings.

The personal computer 120 is an example of an information processing apparatus, which transmits the print job to the MFP 110, or performs processing such as displaying and editing an image scanned by the MFP 110 or text data (text file) output by the MFP 110. In another embodiment, the personal computer 120 may be configured as an image processing apparatus at least having an image processing function. For example, the personal computer 120 may process the document image obtained by the MFP 110 and convert the document image into a text data file including character strings. In such case, the MFP 110 does not have to be provided with the function of converting the document image into a text data file.

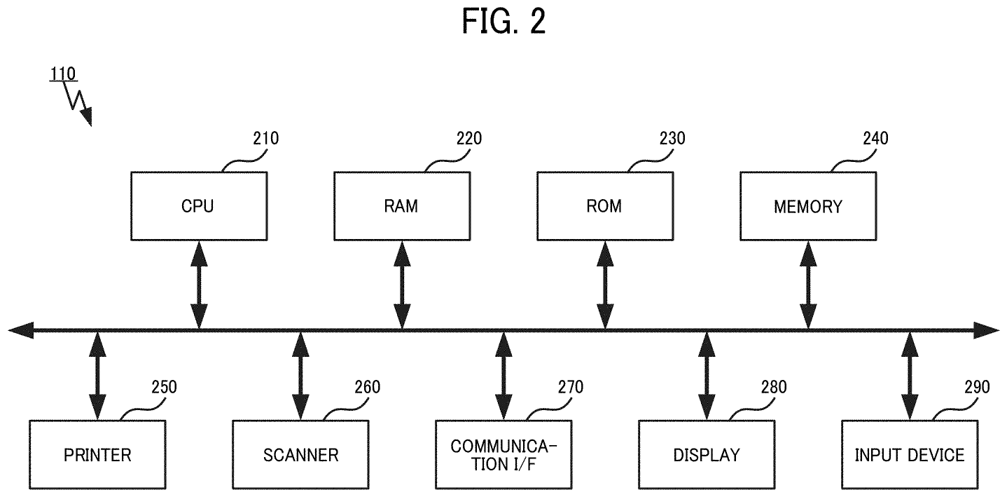

Next, a hardware configuration of the MFP 110 will be described. FIG. 2 is a diagram illustrating a hardware configuration of the MFP 110 according to the present embodiment. The MFP 110 includes a central processing unit (CPU) 210, a random access memory (RAM) 220, a read only memory (ROM) 230, a memory 240, a printer 250, a scanner 260, a communication interface (I/F) 270, a display 280, and an input device 290, connected with each other via a bus.

The CPU 210 executes a program for controlling operation of the MFP 110 to perform various processing using the MFP 110. The RAM 220 is a volatile memory functioning as an area for deploying a program executed by the CPU 210, and is used for storing or expanding programs and data. The ROM 230 is a non-volatile memory for storing such as programs and firmware to be executed by the CPU 210.

The memory 240 is a readable and writable non-volatile memory that stores OS for operating the MFP 110, various software, setting information, or various data. Examples of the memory 240 include a Hard Disk Drive (HDD) and a Solid State Drive (SSD).

The printer 250 forms an image on a recording sheet such as paper by a laser method, an inkjet method, or the like. The scanner 260 scans an image of a paper document into a document image. Using the scanner 260 and the printer 250, the MFP 110 copies the paper document to output one or more sheets of copied document images.

The communication I/F 270 connects the MFP 110 to the network 130, and enables the MIT 110 to communicate with other device via the network 130. Communication via the network 130 may be either wired communication or wireless communication, and various data can be transmitted and received using a predetermined communication protocol such as TCP/IP.

The display 280, which may be implemented by a liquid crystal display (LCD), displays various data, an operating state of the MFP 110, etc. to the user. The input device 290, which may be implemented by a keyboard or buttons, allows the user to operate the MFP 110. The display 280 and the input device 290 may be separate devices, or may be integrated into one device as in the case of a touch panel display.

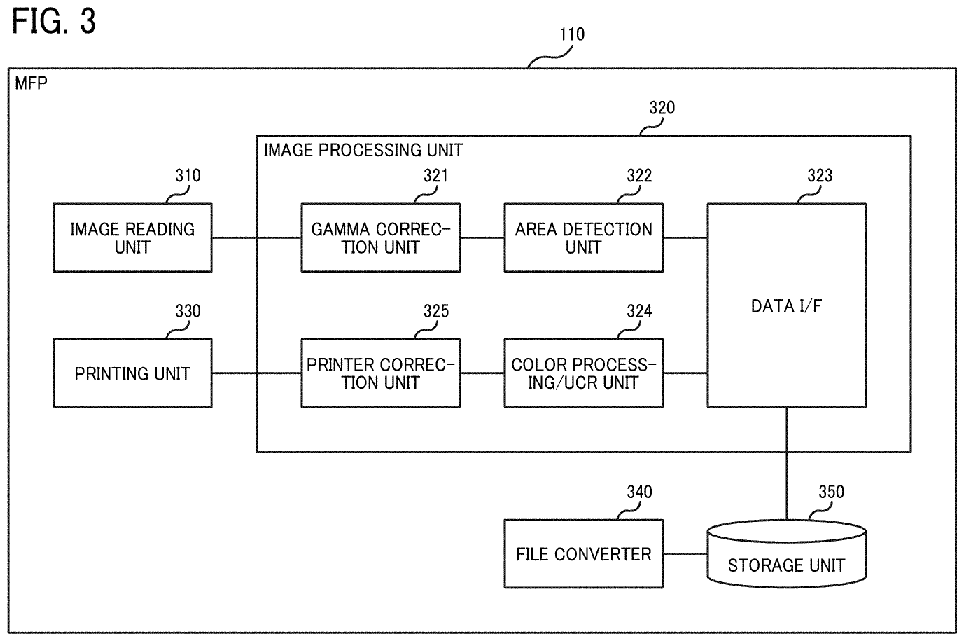

The hardware configuration of the MFP 110 of the present embodiment has been described above. Next, functional units, executed by each hardware of the MFP 110, will be described with reference to FIG. 3, according to the embodiment.

FIG. 3 is a schematic block diagram illustrating software of the MFP 110 according to the present embodiment. For example, the CPU 210 of the MFP 110 may execute a control program stored in any desired memory to implement various modules, such as an image reading unit 310, an image processing unit 320, a printing unit 330, a file converter 340, and a storage unit 350.

The image reading unit 310 controls the scanner 260 to read a document and output image data, which may be referred to as a document image. The image data of the document, read by the image reading unit 310, is output to the image processing unit 320.

The image processing unit 320 performs various correction processing on the image data. The image processing unit 320 includes a gamma correction unit 321, an area detection unit 322, a data I/F unit 323, a color processing/UCR unit 324, and a printer correction unit 325. The image data processed by the image processing unit 320 may be any data such as image data output by the image reading unit 310, image data stored in the storage unit 350, or image data acquired from the personal computer 120 or the like.

The gamma correction unit 321 performs one-dimensional conversion on each signal, to adjust tone balance for each color of image data (8 bits for each of R, G, and B colors after A/D conversion). Here, for the descriptive purposes, a density linear signal (RGB signal) after correction by the gamma correction unit 321 is output to the area detection unit 322 and the data I/F unit 323.

The area detection unit 322 determines whether a pixel or a pixel block of interest in the image data is a character area or a non-character area (that is, a pattern), and further determines whether the pixel or the pixel block of interest is chromatic or achromatic, to detect an area containing the pixel or pixel block of interest. The determination result of the area detection unit 322 (such as the detected area) is output to the color processing/UCR unit 324.

The data I/F unit 323 is an interface for managing HDD such as the memory 240, which temporarily stores the determination result by the area detection unit 322 and the image data corrected by the gamma correction unit 321.

The color processing/UCR unit 324 performs color processing or UCR (under color removal) processing on the image data to be processed, based on the determination result for each pixel or pixel block.

The printer correction unit 325 receives C, M, Y, and Bk image signals from the color processing/UCR unit 324. and performs gamma correction processing and dither processing according to printer characteristics.

The printing unit 330 controls operation of the printer 250 to execute a printing job based on the image data processed by the image processing unit 320.

The file converter 340 converts one or more character strings included in the image data into text data (text file). The image data as the conversion source may be any data such as image data output by the image reading unit 310, image data stored in the storage unit 350, or image data acquired from the personal computer 120. However, in this disclosure, it is assumed that the image data is a document image, which may be a scanned image scanned from a paper document. As an example, the file converter 340 of the present embodiment converts the image data to he in the Office Open XML Document format compatible with word processing software such as MICROSOFT Word. However, a format of the text file is not limited to the one described above, and text files having various formats can be used. In the following, the conversion process in this embodiment will be referred to as “text file con version”.

For example, the file converter 340 may be implemented by the CPU 210 executing a text file conversion program.

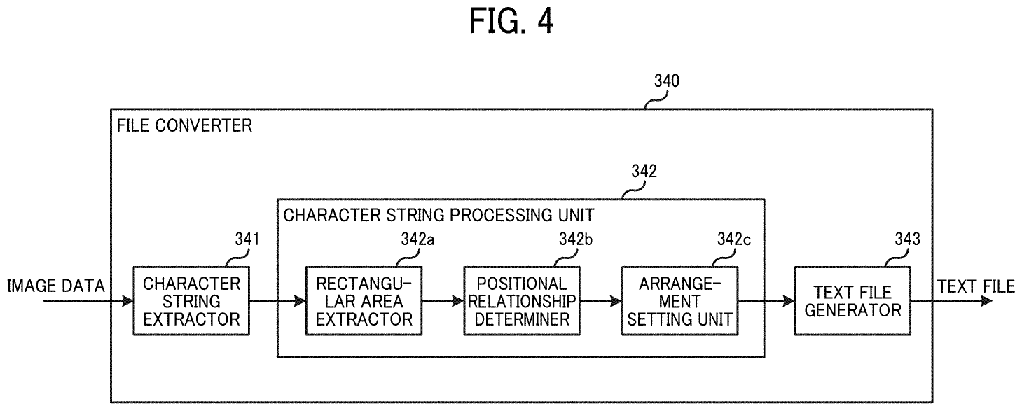

The detailed processing performed by the file converter 340 will be described with reference to FIG. 4. FIG. 4 is a diagram illustrating functions (processing) performed by the file converter 340 of the present embodiment. The file converter 340 converts image data into a text file, and includes a character string extractor 341, a character string processing unit 342. and a text file generator 343.

The character string extractor 341 performs Optical Character Recognition (OCR) processing on the image data to extract one or more character strings in the image. The character string extractor 341 outputs data of the extracted character strings to the character string processing unit 342 together with the image data as the text file conversion source. The method for extracting the character strings in the image is not limited to OCR, such that any other method may be used. For example, alternatively, character strings in the image may be extracted using any known character recognition technique such as image area segmentation.

The character string processing unit 342 selects an arrangement pattern of respective character strings in the text file, which are extracted by the character string extractor 341 from the image. Example arrangement patterns of the character string in the text file include, but not limited to, a pattern in which the character strings are arranged in a text box, and a pattern in which the character strings are arranged in a body of the text file. In the embodiment described below, the character strings arranged in the body of the text file is referred to as “standard text”. When a plurality of character strings is extracted from the image, a text file in which the character strings arranged in the text box and the character strings arranged as standard text are mixed may be generated.

As illustrated in FIG. 4, the character string processing unit 342 includes a rectangular area extractor 342a, a positional relationship determiner 342b, and an arrangement setting unit 342c.

The rectangular area extractor 342a extracts a rectangular area (hereinafter, referred to as a “line rectangular area”) surrounding a character string of one line. When a plurality of character strings is extracted from the image, the rectangular area extractor 342a extracts a line rectangular area for each character string.

The positional relationship determiner 342b determines the positional relationship of the respective line rectangular areas that are extracted. The positional relationship determiner 342b determines layout of the character strings based on the positional relationship between one line rectangular area and other line rectangular area that are adjacent with each other or close to each other. For example, the positional relationship determiner 342b determines whether one line rectangular area has a column relationship with other line rectangle area, has a multi-layer relationship with other line rectangular area, or has neither a column relationship nor a multi-layer relationship. The positional relationship determiner 342b outputs this determination result for each line rectangular area to the arrangement setting unit 342c.

The arrangement setting unit 342c sets an arrangement pattern of each character string based on the determination result of the positional relationship determiner 342b. For example, the arrangement setting unit 342c sets, for example, an arrangement pattern of the character strings, such that one or more character strings included in the line rectangular area having a column relationship or a multi-layer relationship with other line rectangular areas are arranged in the text box. Further, the arrangement setting unit 342c sets an arrangement pattern of the character strings, such that one or more character strings included in the line rectangular area whose relationship with the other line rectangular area is neither the column relationship nor the multi-layer relationship are arranged as the standard text.

The text file generator 343 generates a text file in an Office Open XML Document format, in which each character string is arranged in the image data according to corresponding arrangement pattern having been set by the character string processing unit 342. The text file generated by the text file generator 343 is stored in the storage unit 350 or transmitted to the personal computer 120 to be used for re-editing of the text.

As described above, the software block described above referring to FIG. 4 corresponds to functional units, implemented by the CPU 210 executing the file conversion program of the present embodiment. In any one of the above-described embodiments, all of the above-described functional units of the MFP 10 may be implemented by software, hardware, or a combination of software and hardware.

Further, all of the above-described functional units do not necessarily have to be included in the MFP 110 as illustrated in FIGS. 3 and 4. For example, in other preferred embodiment, when the personal computer 120 is configured as an image processing apparatus, the personal computer 120 may include the file converter 340. In such case, the personal computer 120 is installed with the file conversion program, which causes a processor of the personal computer 120 to have functional units described referring to FIG. 4.

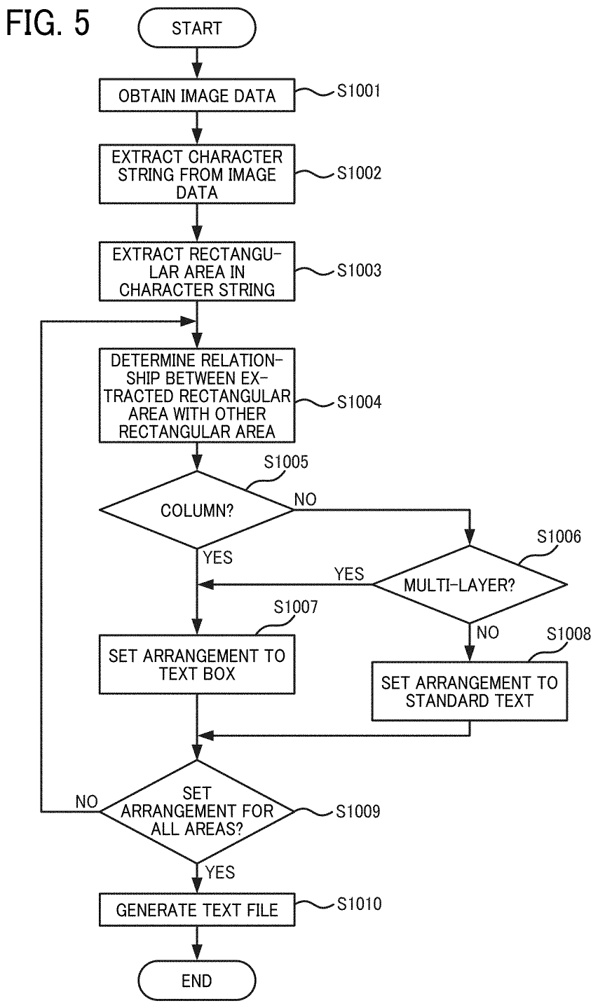

The software configuration of the MFP 110 of the present embodiment is described above. Next, processing executed by the MFP 110 will be described according to the embodiment. FIG. 5 is a flowchart illustrating processing of converting a text file, performed. by the CPU 210 of the MFP 110, according to the present embodiment.

After the MIT 110 starts the text file conversion processing, at S1001, the MFP 110 obtains image data to be converted into a text file. The image data to be processed in the text file conversion may be any data such as image data output by the image reading unit 310, image data stored in the storage unit 350, or image data acquired from another device such as the personal computer 120.

Next, at S1002, the character string extractor 341 applies such as OCR processing to extract one or more character strings included in the obtained image data. In this example, it is assumed that a plurality of character strings is included in the image. After S1002, the character string processing unit 342 performs the following processing on each of the extracted character strings.

At S1003, the rectangular area extractor 342a extracts one or more line rectangular areas for each character string extracted at S1002. For each line rectangular area, the following processing is performed. At S1004, the positional relationship determiner 342b determines a positional relationship between one line rectangular area and other line rectangular area. At S1005, based on a result of the determination at S1004, the operation proceeds to different steps. Specifically, the positional relationship determiner 342b determines whether or not the positional relationship determined at S1004 indicates that the one line rectangular area has a column relationship with the other line rectangular area. If the positional relationship indicates a column relationship (YES), the operation proceeds to S1007. If the positional relationship indicates no column relationship (NO), the operation proceeds to S1006.

At S1006, based on a result of the determination at S1004, the operation proceeds to different steps. Specifically, the positional relationship determiner 342b determines whether or not the positional relationship determined at S1004 indicates that the one line rectangular area has a multi-layer relationship with the other line rectangular area. If the positional relationship indicates a multi-layer relationship (YES), the operation proceeds to S1007. If the positional relationship indicates no multi-layer relationship (NO), the operation proceeds to S1008.

When the one line rectangular area has a column relationship or a multi-layer relationship with another line rectangular area (YES at S1005 or S1006), at S1007, the arrangement setting unit 342c sets an arrangement pattern, such that the one or more character strings of the one line rectangular area are arranged in the text box. On the other hand, when the one line rectangle area and the other line rectangle area have neither a column relationship nor a multi-layer relationship, at S1008, the arrangement setting unit 342c sets an arrangement pattern, such that the one or more character strings for the one line rectangle area are arranged as standard text.

After setting the arrangement pattern for the character strings of the one line rectangular area in the text file at S1007 or S1008, at S1009, it is determined whether or not an arrangement pattern is set for all line rectangular areas, if the arrangement pattern is not set for all line rectangular areas (NO), that is, if there is an unset line rectangular area, operation returns to S1004, and the above-described processing of determining and setting the arrangement pattern is performed for other line rectangular area that is unprocessed. When the arrangement pattern is set for all line rectangular areas (YES), operation proceeds to S1010.

At S1010, the text file generator 343 generates a text file in which each character string is arranged according to the arrangement pattern that is set. The generated text tile may be stored in the storage unit 350 or may be transmitted to the personal computer 120. After S1010, the MFP 110 ends the text file conversion processing, according to the present embodiment.

Through processing illustrated in FIG. 5, the MFP 110 is able to convert the image data into a text file, while considering layout of sentences (character strings) included in the image. Since the resultant text file accurately reflects a structure of character strings of the original document, the user does not have to re-edit the text file, thus improving operability for the user.

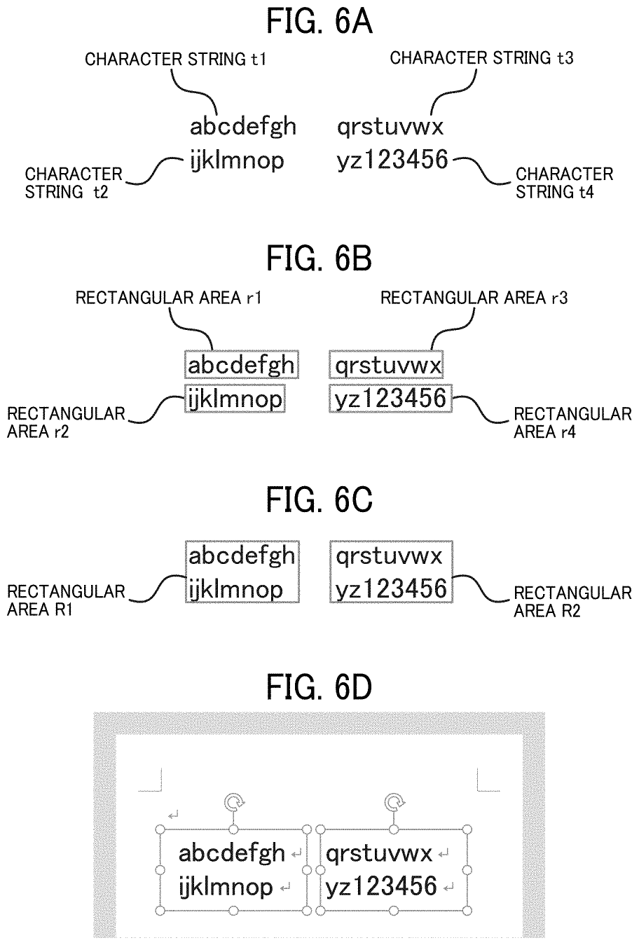

Next, with reference to FIGS. 6A to 8D, specific examples of text file conversion will be described according to the present embodiment.

Referring to FIGS. 6A to 6D, one example case is described. FIGS. 6A to 6D are an illustration for explaining an example of generating a text file including character strings having a column relationship in the text file conversion process according to the present embodiment.

FIG. 6A illustrates an example in which character strings are extracted from image data to be converted into a text file, by applying such as OCR processing. In the example illustrated in FIG. 6A, the character strings “abcdefgh” (character string t), “ijklmnop” (character string t2), “qrstuvwx” (character string t3), and “yz123456” (character string 14) are extracted from the image.

FIG. 6B illustrates an example in which a line rectangular area is extracted for each character string of FIG. 6A. In the example illustrated in FIG. 6B, the rectangular area extractor 342a extracts a rectangle surrounding the character string t1 as a line rectangular area r1, a rectangle surrounding the character string t2 as a line rectangular area r2, a rectangle surrounding the character string t3 as a line rectangular area r3, and a rectangle surrounding the character string t4 as a line rectangular area r4, respectively.

FIG. 6C illustrates example operation of determining the positional relationship between one line rectangular area having been extracted and other line rectangular area, performed by the positional relationship determiner 342b. In the example illustrated in FIG. 6C, since the line rectangular area r1 and the line rectangular area r2 illustrated in FIG. 6B are close to each other, the positional relationship determiner 342b determines to combine the areas r1 and r2 to form a new rectangular area R1. Similarly in FIG. 6C, since the line rectangular area r3 and the line rectangular area r4 illustrated in FIG. 6B are close to each other, the positional relationship determiner 342b determines to combine the areas r3 and r4 to form a new rectangular area R2. On the other hand, the positional relationship determiner 342b determines that the line rectangular area R1 and the line rectangular area R2 are not close to each other, such that these areas R1 and R2 are character strings having a column relationship. Accordingly, the arrangement setting unit 342c sets an arrangement pattern such that the line rectangular area R1 and the line rectangular area R2 are arranged in different text boxes. More specifically, the positional relationship determiner 342b determines that the line rectangular areas that are sufficiently close (for example, a distance therebetween is less than a preset value), are arranged in the same text box. The positional relationship determiner 342b determines that the line rectangular areas that are not sufficiently close (for example, a distance therebetween is equal to or greater than the preset value), are arranged in different text boxes. As described above, the line rectangular area represents one or more character strings.

FIG. 6D illustrates an example display screen of a text file in which each character string is arranged based on an arrangement pattern set by the arrangement setting unit 342c. Since the line rectangular area R1 and the line rectangular area R2 are set to be arranged in the separate text boxes, in the example of FIG. 6D, a text file contains the text box in which the character string t1 and the character string t2 are arranged, and the text box in which the character string t3 and the character string t4 are arranged.

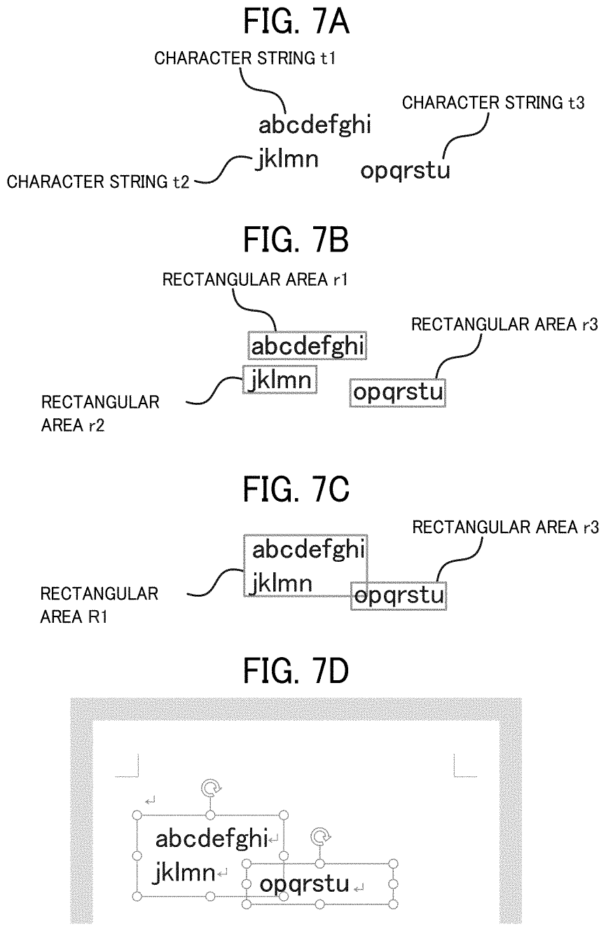

Referring to FIGS. 7A to 7D, another example case is described. FIGS. 7A to 7D are an illustration for explaining an example of generating a text file including character strings having a multi-layer relationship in the text file conversion process according to the present embodiment.

FIG. 7A illustrates an example in which character strings are extracted from image data to be converted into a text file, by applying such as OCR processing. In the example illustrated in FIG. 7A, the character strings “abcdefghi” (character string t1), “jklmn” (character string t2), and “opqrstu” (character string t3) are extracted from the image.

FIG. 7B illustrates an example in which a line rectangular area is extracted for each character string of FIG. 7A. In the example illustrated in FIG. 7B, the rectangular area extractor 342a extracts a rectangle surrounding the character string t1 as a line rectangular area r1, a rectangle surrounding the character string t2 as a line rectangular area r2, and a rectangle surrounding the character string 13 as a line rectangular area r3, respectively.

FIG. 7C illustrates example operation of determining the positional relationship between one line rectangular area having been extracted and other line rectangular area, performed by the positional relationship determiner 342b. In the example illustrated in FIG. 7C, since the line rectangular area r1 and the line rectangular area r2 illustrated in FIG. 7B are close to each other, the positional relationship determiner 342b determines to combine the areas r1 and r2 to form a new rectangular area R1. The resultant line rectangular area R1 partly overlaps with the line rectangular area r3. That is, the positional relationship determiner 342b determines that the line rectangular area R1 and the line rectangular area r3 are character strings having a multi-layer relationship. Accordingly, the arrangement setting unit 342c sets an arrangement pattern such that the line rectangular area R1 and the line rectangular area r3 are arranged in different text boxes. More specifically, the positional relationship determiner 342b determines that the line rectangular areas that overlap with each other (for example, coordinates of the areas or a distance therebetween indicate that the areas overlap), are arranged in different text boxes. As described above, the line rectangular area represents one or more character strings.

FIG. 7D illustrates an example display screen of a text file in which each character string is arranged based on an arrangement pattern set by the arrangement setting unit 342c. Since the line rectangular area R1 and the line rectangular area r3 are set to be arranged in the different text boxes, in the example of FIG. 7D, a text file contains the text box in which the character string t1 and the character string t2 are arranged, and the text box in which the character string t3 is arranged.

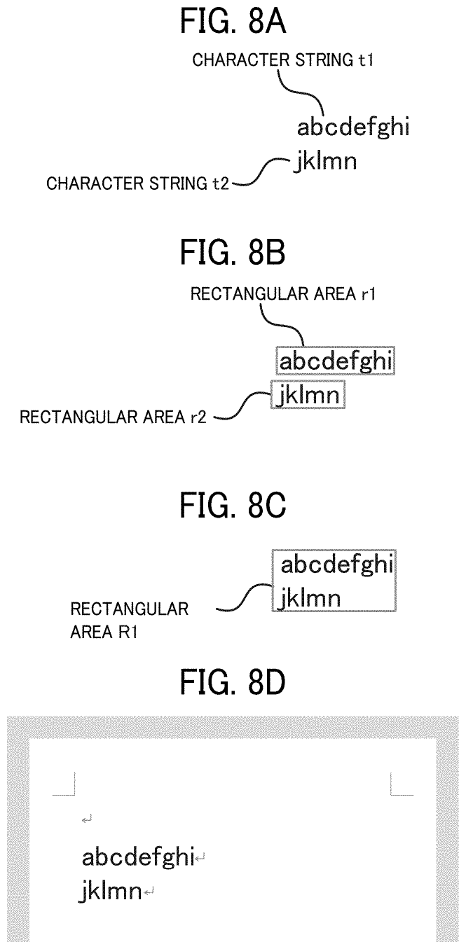

Referring to FIGS. 8A to 8D, another example case is described. FIGS. 8A to 8D are an illustration for explaining an example of generating a text file including character strings having neither column relationship nor multi-layer relationship in the text file conversion process according to the present embodiment.

FIG. 8A illustrates an example in which character strings are extracted from image data to be converted into a text file, by applying such as OCR processing. In the example illustrated in FIG. 8A, the character strings “abcdefghi” (character string t1) and “jklinn” (character string t2) are extracted from the image.

FIG. 8B illustrates an example in which a line rectangular area is extracted for each character string of FIG. 8A. In the example illustrated in FIG. 8B, the rectangular area extractor 342a extracts a rectangle surrounding the character string t1 as a line rectangular area r1, and a rectangle surrounding the character string t2 as a line rectangular area r2, respectively.

FIG. 8C illustrates example operation of determining the positional relationship between one line rectangular area having been extracted and other line rectangular area, performed by the positional relationship determiner 342b. In the example illustrated in FIG. 8C, since the line rectangular area r1 and the line rectangular area r2 illustrated in FIG. 8B are close to each other, the positional relationship determiner 342b determines to combine the areas r1 and r2 to form a new rectangular area R1. Since there is no other line rectangular area that is adjacent to the line rectangular area R1, the positional relationship determiner 342b determines that the line rectangular area R1 is a character string that has neither column relationship nor multi-layer relationship with other line rectangular area. Accordingly, the arrangement selling unit 342c sets an arrangement pattern such that the line rectangular area R1 is arranged as standard text.

FIG. 8D illustrates an example display screen of a text file in which each character string is arranged based on an arrangement pattern set by the arrangement setting unit 342c. Since the line rectangular area R1 is set to be arranged as standard text, in the example of FIG. 8D, a text file in which the character string t1 and the character string t2 are arranged in the body of the text file is generated.

Specific examples in text file conversion process are illustrated according to the present embodiment. As described above, the positional relationship between line rectangular areas may be determined according to the degree of proximity (distance) between the adjacent line rectangular areas. However, the embodiment is not limited to the above-described example, such that the positional relationship may be determined based on any other parameter. Further, the positional relationship may be based on one or more parameters determined by machine learning.

In the present disclosure, machine learning is a technique that enables a computer to acquire human-like learning ability. Machine learning refers to a technology in which a computer autonomously generates an algorithm required for determination such as data identification from learning data loaded in advance, and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

According to one or more embodiments, an image processing apparatus, a system, a conversion method, and a control program are provided, each of which is capable of improving reproducibility of character strings included in a document image, such that a text data file reflects contents of the document image more accurately.

Each function in the exemplary embodiment may be implemented by a program described in C, C++, C# or Java (registered trademark). The program may be provided using any storage medium that is readable by an apparatus, such as a hard disk drive, compact disc (CD) ROM, magneto-optical disc (MO), digital versatile disc (DVD), a flexible disc, erasable programmable read-only memory (EPROM), or electrically erasable PROM. Alternatively, any program may be transmitted via a network to be distributed to other apparatus.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), and field programmable gate array (FPGA), and conventional circuit components arranged to perform the recited functions.

The above-described embodiments are illustrative and do not limit the present invention. Thus, numerous additional modifications and variations are possible in light of the above teachings. For example, elements and/or features of different illustrative embodiments max be combined with each other and/or substituted for each other within the scope of the present invention. Any one of the above-described operations may be performed in various other ways, for example, in an order different from the one described above.

1. An image processing apparatus comprising:
circuitry configured to:
obtain image data of a document;
determine an arrangement pattern of each of a plurality of character strings in the image data, based on positional relationship of the plurality of character strings; and
generate a text data file including the plurality of character strings each being arranged according to the arrangement pattern that is determined.

2. The image processing apparatus of claim 1, wherein the arrangement pattern indicates whether to arrange each character string in a text box, or as standard text, in the text data file.

3. The image processing apparatus of claim 2, wherein the circuitry determines that, of the plurality of character strings, at least two character strings being adjacent with each other are arranged in different text boxes, based on a determination that the at least two character strings have a column relationship.

4. The image processing apparatus of claim 1, wherein the circuitry determines that the at least two character strings have a column relationship, based on a distance between the at least two character strings.

5. The image processing apparatus of claim 2, wherein the circuitry determines that, of the plurality of character strings, at least two character strings being adjacent with each other are arranged in different text boxes, based on a determination that the at least two character strings have a multi-layer relationship.

6. The image processing apparatus of claim 2, wherein the circuitry determines that, of the plurality of character strings, at least two character strings are arranged as standard text, based on a determination that the at least two character strings have neither a column relationship nor a multi-layer relationship.

7. The image processing apparatus of claim 1, wherein the circuitry extracts the plurality of character strings from the image data by OCR processing or image area segmentation.

8. The image processing apparatus of claim 1, further comprising:
a scanner configured to scan a paper document into the image data,
wherein the circuitry extracts the plurality of character strings from the image data that is scanned.

9. A system comprising:
the image processing apparatus of claim 1; and
a scanner configured to scan a paper document into the image data, wherein the image processing apparatus receives the image data from the scanner.

10. A method for converting an image into a text data file, comprising:
obtaining image data of a document;
determining an arrangement pattern of each of a plurality of character strings in the image data, based on positional relationship of the plurality of character strings; and
generating a text data file including the plurality of character strings each being arranged according to the arrangement pattern that is determined.

11. The method of claim 10, wherein the arrangement pattern indicates whether to arrange each character string in a text box, or as standard text, in the text data file.

12. The method of claim 11, wherein the determining includes:
determining that, of the plurality of character strings, at least two character strings being adjacent with each other are arranged in different text boxes, based on a determination that the at least two character strings have a column relationship.

13. The method of claim 11, wherein the determining includes:
determining that, of the plurality of character strings, at least two character strings being adjacent with each other are arranged in different text boxes, based on a determination that the at least two character strings have a multi-layer relationship.

14. The method of claim 11, wherein the determining includes: determining that, of the plurality of character strings, at least two character strings are arranged as standard text, based on a determination that the at least two character strings have neither a column relationship nor a multi-layer relationship.

15. The method of claim 10, further comprising:
extracting the plurality of character strings from the image data by OCR processing or image area segmentation.

16. The method of claim 10, further comprising:
scanning a paper document into the image data,
wherein the extracting includes extracting the plurality of character strings from the image data that is scanned.

17. A non-transitory recording medium storing a plurality of instructions which, when executed by one or more processors, causes the one or more processors to perform a method for converting an image into a text data file, the method comprising:
obtaining image data of a document;
determining an arrangement pattern of each of a plurality of character strings in the image data, based on positional relationship of the plurality of character strings; and
generating a text data file including the plurality of character strings each being arranged according to the arrangement pattern that is determined.
